(19) United States
(12) Patent Application Publication
(10) Pub. No.: US 2024/0373879 A1
(43) Pub. Date: Nov. 14, 2024

(54) PET TREAT WITH EDIBLE RELEASABLE ATTACHMENT TO ANOTHER OBJECT AND METHODS OF USE

(71) Applicant: Spectrum Brands, Inc., Middleton, WI (US)

(72) Inventors: Tiffany Dawn Potter, Pearisburg, VA (US); Mollie Backode, Blacksburg, VA (US); Lee Yang, Creve Coeur, MO (US); Chanda Musgraves, Lake Saint Louis, MO (US); William Nathan Brunner, St. Peters, MO (US); Gregory van Eyk, Christiansburg, VA (US)

(21) Appl. No.: 18/195,664

(22) Filed: May 10, 2023

(51) Int. Cl. A23K 40/20; A23K 10/20; A23K 10/30

(52) U.S. Cl. CPC A23K 40/20; A23K 10/20; A23K 10/30

(57) ABSTRACT

A completely edible pet treat is releasably attachable to another object, such as a camera or a mobile device having a camera. The pet treat includes a 100% edible fastening member, shaped and sized to be releasably attached to the object, and a 100% edible remaining member integral with the fastening member, sized to be visible to a pet, when the pet treat is attached to the object.

### TECHNICAL FIELD

This disclosure relates to completely edible pet treat that can be releasable attached to another object, such as a camera or mobile device with a camera. Methods of use are also described.

### BACKGROUND

Pet owners often desire to take pictures of their pets, e.g., their dogs, with their mobile device, e.g., their cellular phones or another camera. This often proves difficult because the pet may or may not want to sit or stand in a still position so that the picture can be taken. Solutions to this problem are desirable.

### SUMMARY

In general, a completely edible pet treat for releasable attachment to another object is provided. The pet treat comprises a 100% edible fastening member, shaped and sized to be releasably attached to the object; and a 100% edible remaining member integral with the fastening member, sized to be visible to a pet, when the pet treat is attached to the object.

In example embodiments, the fastening member is hook-shaped.

In some implementations, the remaining member is shaped to simulate an appearance of food.

In some examples, the remaining member is shaped to simulate an appearance of a bone.

The fastening member may include a holder section and a bridge section. The bridge section extends between the remaining member and the holder section. The holder section is spaced from and in opposition to the remaining member to define an object-receiving space between the holder section and the remaining member, and such that the bridge section is positioned to hang on the object.

In examples, the holder section is spaced between 1-2 cm from the remaining member.

In one or more embodiments, the pet treat further comprises a 100% edible gusset section extending between the bridge section and the remaining member, on a side of the bridge section opposite of the holder section

In some implementations, the pet treat comprises at least 30% rice flour; at least 15-25% sweet potato powder; at least 10-20% protein; at least 5-15% humectant; and at least 3-7% peanut butter.

In some examples, the pet treat includes at least one of: 2-5% honey; 2-5% bacon; or 2-5% cheese.

Some embodiments further include 5-15% calcium carbonate.

In some examples, the at least 10-20% protein consists essentially of chicken.

In examples, the remaining portion has a length of 5-10 cm and a height of 3-8 cm.

In another aspect, a method of using a 100% edible pet treat is provided. The method includes releasably attaching the pet treat to an object with a 100% edible fastening member; the fastening member being integral with a 100% edible remaining member; the remaining member sized to be visible to a pet.

In example methods, the step of releasably attaching includes attaching the pet treat to a mobile device having a camera.

In example methods, the fastening member is hook shaped, and the step of releasably attaching includes hanging the pet treat onto the mobile device using the hook shaped fastening member.

In some methods, the remaining member has the appearance of food.

In some methods, the remaining member has the appearance of a bone.

In some implementations, the pet treat comprises at least 30% rice flour; at least 15-25% sweet potato powder; at least 10-20% protein; at least 5-15% humectant; and at least 3-7% peanut butter.

A variety of examples of desirable product features or methods are set forth in part in the description that follows, and in part will be apparent from the description, or may be learned by practicing various aspects of this disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is a front perspective view of a pet treat, constructed in accordance with principles of this disclosure;

FIG. 2 is a rear perspective view of the pet treat of FIG. 1;

FIG. 3 is a front elevational view of the pet treat of FIG. 1;

FIG. 4 is a rear elevational view of the pet treat of FIG. 1;

FIG. 5 is a right side elevational view of the pet treat of FIG. 1;

FIG. 6 is a left side elevational view of the pet treat of FIG. 1;

FIG. 7 is a top plan view of the pet treat of FIG. 1;

FIG. 8 is a bottom plan view of the pet treat of FIG. 1;

FIG. 9 is a front elevational view of the pet treat releasably mounted to a mobile device having a camera;

FIG. 10 is a rear elevational view of the pet treat and mobile device of FIG. 9; and

FIG. 11 is a side elevational view of FIGS. 9 and 10.

### DETAILED DESCRIPTION

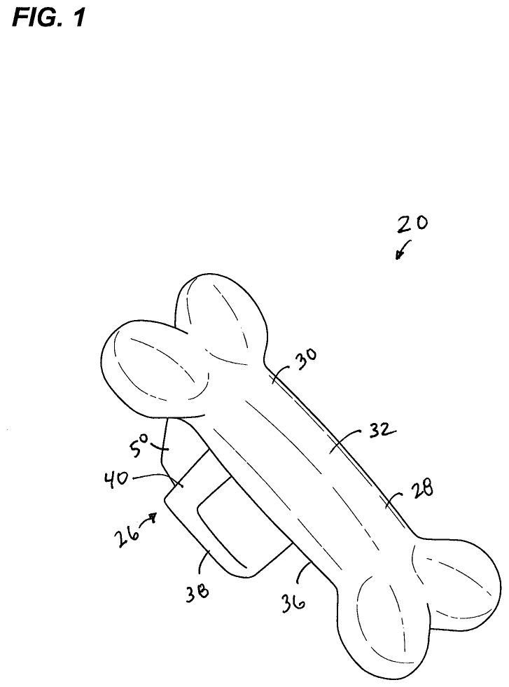

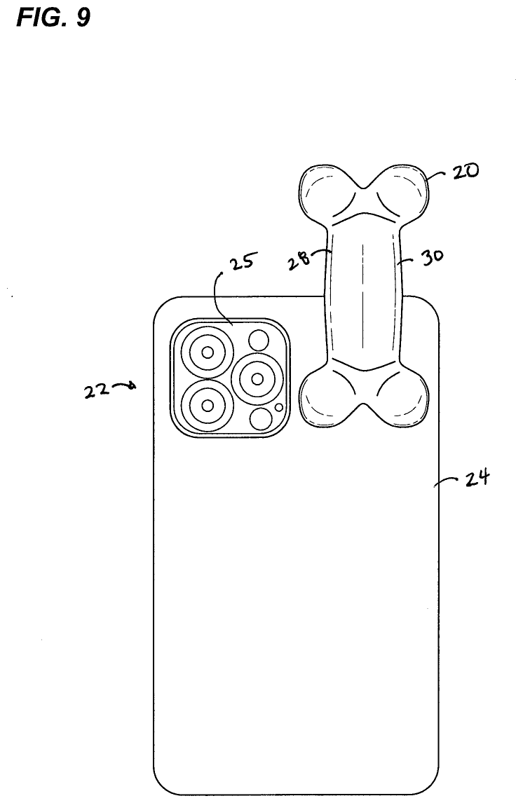

In reference first to FIGS. 1 and 9, an example embodiment of a pet treat 20 for releasable attachment to another object 22 is shown. The object 22 can be a mobile device 24 having a camera 25, such as a cell phone with a camera 25. The object 22 can also be a just a camera or any device which it is desired to draw a pet's attention.

The pet treat 20 is completely edible. By “completely edible”, it means that all parts including the fastening member (described below) are made from ingredients appropriate and desirable for consumption by an animal, such as a dog.

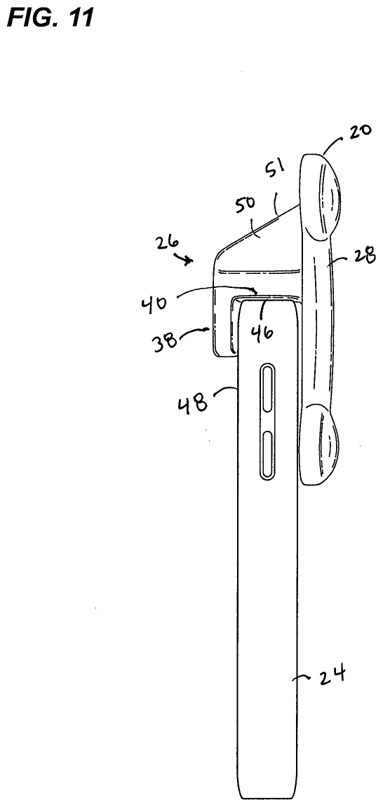

The pet treat 20 has a 100% edible fastening member 26, shaped and sized to be releasably attached to the object 22. The fastening member 26 can be many shapes. In the example shown in the drawings, the fastening member 26 is hook-shaped. As can be seen in FIG. 11, the hook-shaped fastening member 26 is useful for hooking or hanging or otherwise securing the pet treat 20 to the object 22 or mobile device 24.

The pet treat 20 further includes a 100% edible remaining member 28 integral with the fastening member 26. The remaining member is sized to be visible to a pet, when the pet treat 20 is attached to the object 22. The remaining member 26 can have a variety of appearances. For example, the remaining member 26 can be shaped and sized to simulate the appearance of a desirable food item. In the example shown, the remaining member 26 has the appearance of a bone 30.

The remaining member 26 has an outward face 32 and an opposite inward face 34. In use, the outward face 32 is visible to the pet, while the inward face 34 is facing or is against the object 22 or mobile device 24. Extending between the outward face 32 and inward face 34 is a sidewall 36 forming an outer periphery.

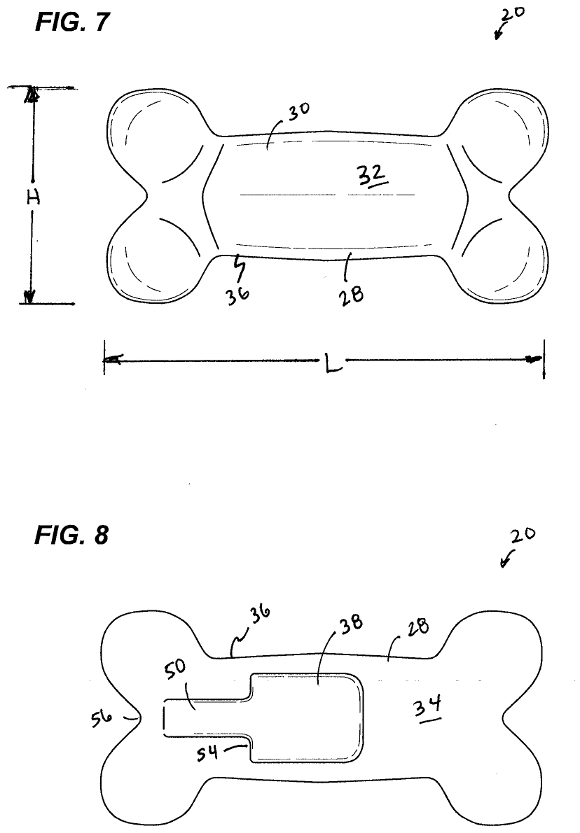

The remaining member 26 can be a variety of sizes. For example, the remaining member 26 can have an overall length L (FIG. 7) of at least 3 cm; preferably at least 4 cm; no greater than 12 cm; and often 5-10 cm. The remaining member 26 can have an overall height H (FIG. 7) of at least 2 cm, no greater than 12 cm, and preferably 3-8 cm.

The outward face 32 is preferably sized to accommodate words, or pictures, or a combination of words and pictures. The words can be branding or trademarks, and/or may include pet affirmations or expressions such as “good dog”; “self-paw-trait”; “pup-arazzi”, etc.

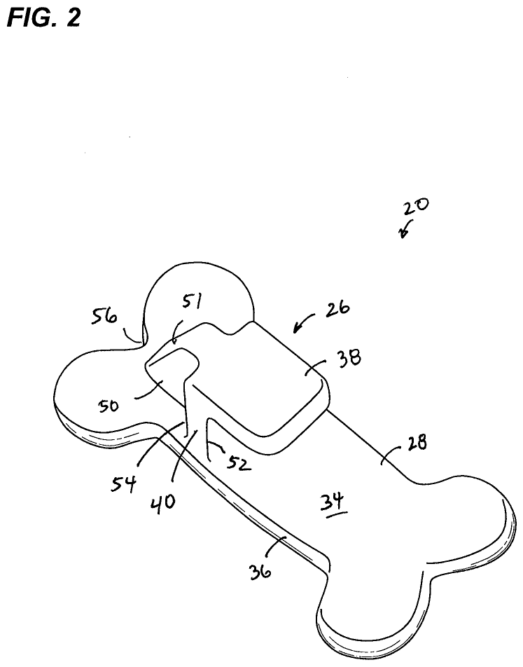

In reference now to FIGS. 2-4, the fastening member 26 has a holder section 38 and a bridge section 40. The bridge section 40 extends between and joins the remaining member 26 and the holder section 38. In the example shown in the drawings, the bridge section 40 is generally orthogonal to the inward face 34 of the remaining member 28. The holder section 38 is generally parallel to the remaining member 28.

The holder section 38 is spaced from and in opposition to the inward face 34 of the remaining member 28 to define an object-receiving space 42 between the holder section 38 and the remaining member 28, and such that the bridge section 40 is positioned to hang on the object 22.

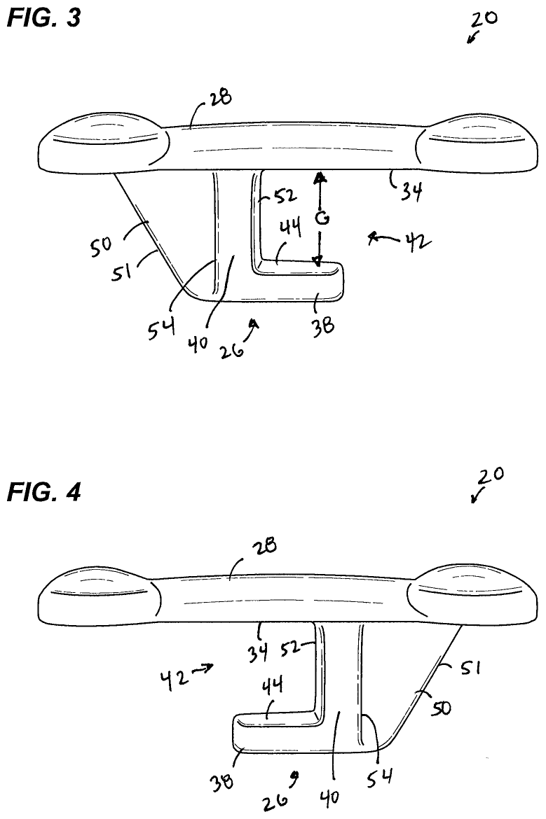

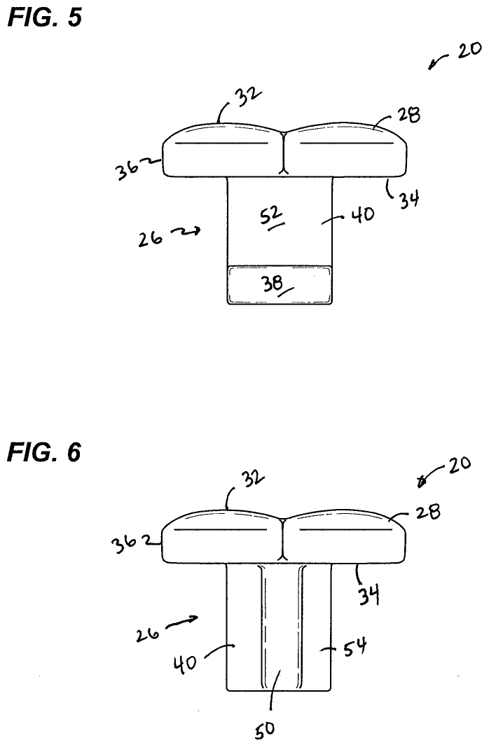

The object-receiving space 42 is sized to receive, for example, mobile device 24. The object-receiving space 42 is defined by the gap G (FIG. 3) between the inward face 34 of the remaining member 28 and an inward surface 44 of the holder section 38. The gap G is at least 0.8 cm, typically 1-2 cm, and usually not greater than 4 cm.

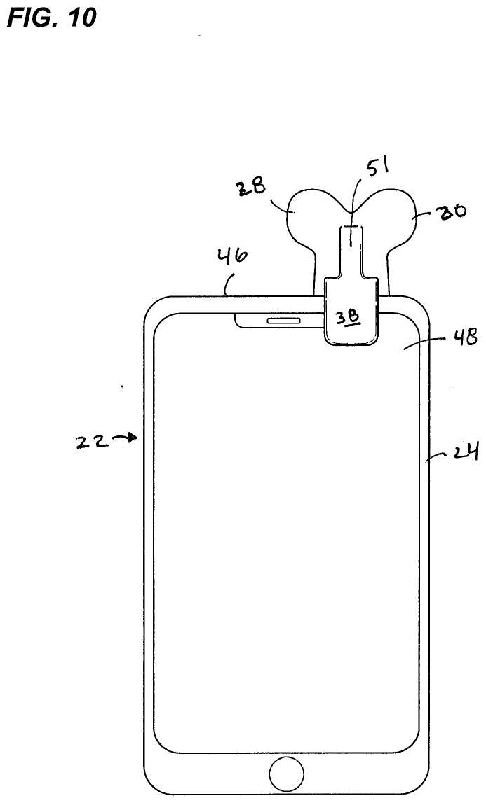

In FIGS. 10 and 11, it can be seen how the bridge section 40 is positioned to rest over and against an upper side 46 of the mobile device 24, while the holder section 38 extends partially along one of the faces 48 of the mobile device 24. Specifically, at least some portions of the inward surface 44 of the holder section 38 is against the face 48 of the mobile device 24.

While the construction can vary, in the embodiment shown, the holder section 38 has a length less than 75%, often less than 60%, and preferably less than 50% of the overall length L of the remaining member 28. Typically, the holder section 38 is 20-40% of the length of the remaining member 28. In the non-limiting example shown, the holder section 38 has a width less than the width of the narrowest part of the remaining member 28.

The pet treat 20 further comprises a 100% edible gusset section 50 extending between the bridge section 40 and the remaining member 28, opposite of the holder section 38. That is, a first side 52 of the bridge section 40 has the holder section 38 projecting generally perpendicular therefrom, and an opposite second side 54 of the bridge section 40 has the gusset section 50 extending therefrom. An angled side 51 extends from the remaining member 28 and inwardly toward the bridge section 40. The gusset section 50 helps to reinforce and prevent unintended breakage at the bridge section 40.

While there can be many variations, in FIGS. 3, 4, and 8, it can be appreciated that, in the preferred embodiment shown, the gusset section 50 extends from adjacent to (but spaced from) an end 56 of the remaining member 28 to the bridge section 40. The bridge section 40 extends from the end 56 at a location between 10-50% of the overall length L of the remaining member 28, for example, about 20-40% of the overall length L.

The overall appearance of the pet treat 20 can be changed, as desired. The specific one shown, including the relative proportions, was selected because it is attractive in appearance and eye-catching.

The pet treat 20 can be made from a variety of ingredients, generally attractive to the taste buds of dogs, but the ingredients can be varied to target a variety of pets. The ingredients are also provided to give the pet treat 20 a texture that holds its shape and allows it to be attached to object 22 (e.g., mobile device 24 with camera 25).

For example, many pet treats 20 will comprise at least 30% rice flour; at least 15-25% sweet potato powder; at least 10-20% meat protein; at least 5-15% humectant (e.g., glycerin); and at least 3-7% peanut butter. Many pet treats 20 can further include at least one of: 2-5% honey; 2-5% bacon; or 2-5% cheese. Many pet treats 20 can include 5-15% calcium carbonate. In some cases, the at least 10-20% meat protein will either consist, or consist essentially, of chicken. The pet treats 20 can be in a variety of flavors, including peanut butter honey; bacon; chicken and sweet potato; chicken and cheese; and chicken and peanut butter.

Example methods of use

The pet treat 20 can be used by releasably attaching the pet treat 20 to object 22 with the 100% edible fastening member 26. The fastening member 26 is integral with the 100% edible remaining member 28. The remaining member 28 is sized to be visible to a pet.

The step of releasably attaching includes attaching the pet treat 20 to mobile device 24 having camera 25.

The fastening member 26 is hook shaped, and the step of releasably attaching includes hanging the pet treat 20 onto the mobile device 24 using the hook shaped fastening member 26.

The remaining member 28 will be hanging on the mobile device 24 and will be visible to the pet. While the pet is looking at the remaining member 28, the person holding the mobile device 24 can photograph the pet, as the pet is staring at both the remaining member 28 and the camera 25 of the mobile device 24. When the person is done taking pictures, the person removes the pet treat 20 from the mobile device 24, and gives the pet treat 20 to the pet for consumption. Since the pet treat 20 is 100% edible including the fastening member 26, there is nothing (no clips, etc.) left on the mobile device 24. That is, there are no other tools or fasteners needed to secure the pet treat 20 to the mobile device.

The above disclosure includes example principles. Many embodiments can be made using these principles.

What is claimed is:

1. A completely edible pet treat for releasable attachment to another object; the pet treat comprising:
(a) a 100% edible fastening member, shaped and sized to be releasably attached to the object; and
(b) a 100% edible remaining member integral with the fastening member, sized to be visible to a pet, when the pet treat is attached to the object.

2. The pet treat of claim 1 wherein the fastening member is hook-shaped.

3. The pet treat of claim 1 wherein the remaining member is shaped to simulate an appearance of food.

4. The pet treat of claim 1 wherein the remaining member is shaped to simulate an appearance of a bone.

5. The pet treat of claim 1 wherein the fastening member includes a holder section and a bridge section;
(a) the bridge section extending between the remaining member and the holder section;
(b) the holder section being spaced from and in opposition to the remaining member to define an object-receiving space between the holder section and the remaining member, and such that the bridge section is positioned to hang on the object.

6. The pet treat of claim 5 wherein the holder section is spaced between 1-2 cm from the remaining member.

7. The pet treat of claim 5 further comprising a 100% edible gusset section extending between the bridge section and the remaining member, on a side of the bridge section opposite of the holder section.

8. The pet treat of claim 1, wherein the pet treat comprises at least 30% rice flour; at least 15-25% sweet potato powder; at least 10-20% protein; at least 5-15% humectant; and at least 3-7% peanut butter.

9. The pet treat of claim 8 further including at least one of: 2-5% honey; 2-5% bacon; or 2-5% cheese.

10. The pet treat of claim 8 further including 5-15% calcium carbonate.

11. The pet treat of claim 8 wherein the at least 10-20% protein consists essentially of chicken.

12. The pet treat of claim 1 wherein the remaining portion has a length of 5-10 cm and a height of 3-8 cm.

13. A method of using a 100% edible pet treat; the method comprising:
releasably attaching the pet treat to an object with a 100% edible fastening member; the fastening member being integral with a 100% edible remaining member; the remaining member sized to be visible to a pet animal.

14. The method of claim 13 wherein the step of releasably attaching includes attaching the pet treat to a mobile device having a camera.

15. The method of claim 14 wherein the fastening member is hook shaped, and the step of releasably attaching includes hanging the pet treat onto the mobile device using the hook shaped fastening member.

16. The method of claim 13 wherein the remaining member has the appearance of food.

17. The method of claim 13 wherein the remaining member has the appearance of a bone.

18. The method of claim 13 wherein the pet treat comprises at least 30% rice flour, at least 15-25% sweet potato powder; at least 10-20% protein; at least 5-15% humectant; and at least 3-7% peanut butter.

19. The method of claim 13 further including removing the fastening member and integral remaining member from the object and giving the fastening member and integral remaining member to the pet animal for consumption.

20. The method of claim 14 further including taking a picture of the pet animal, as the pet animal looks at the remaining member.
